(19) United States
(12) Patent Application Publication
(10) Pub. No.: US 2024/0332593 A1
(43) Pub. Date: Oct. 3, 2024

(54) RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Ryotaro SAKAI, Toyota-shi (JP); Kentaro SUZUKI, Kariya-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/621,660

(22) Filed: Mar. 29, 2024

(30) Foreign Application Priority Data
Apr. 3, 2023 (JP) 2023-060222

(51) Int. Cl. H01M 10/04; H01M 4/02; H01M 4/04

(52) U.S. Cl. CPC H01M 10/0431; H01M 4/043; H01M 2004/021

(57) ABSTRACT

A rechargeable battery includes an electrode body formed by rolling a stack of positive and negative electrode sheets with a separator arranged in between. The positive and negative electrode sheets each include an electrode mixture layer. When a pressure is applied for a predetermined time to the electrode mixture layer, impregnated with an electrolyte solution, a weight of the electrolyte solution that flows out of the electrode mixture layer per unit volume of the electrode mixture layer per unit pressure applied is referred to as a fluidity index value of the electrolyte solution. The predetermined time is set to three minutes. The fluidity index value of the electrolyte solution is expressed as “gram (@three minutes) per kilopascal-cubic millimeter”. A value obtained by subtracting the fluidity index value of the negative mixture layer from the that of the positive mixture layer is greater than or equal to 0.48×10\hat{ }-6.

### CROSS-REFERENCE TO RELATED APPLICATIONS

This application is based upon and claims the benefit of priority from prior Japanese Patent Application No. 2023-060222, filed on Apr. 3, 2023, the entire contents of which are incorporated herein by reference.

### BACKGROUND

### 1. Field

The following description relates to a rechargeable battery.

### 2. Description of Related Art

A typical rechargeable battery includes an electrode body formed by rolling a stack of positive and negative electrode sheets with a separator held in between. In such a rechargeable battery, the electrode body is impregnated with an electrolyte solution. The heat generated when a large current flows during high-rate charging or discharging expands the electrolyte solution and electrode mixtures, which form the electrode sheets. This causes the electrolyte solution to flow out of the electrode body. Further, the salt concentration of the electrolyte solution in the electrode body may become uneven, which in turn, increases the internal resistance of the electrode body. This may degrade charging/discharging performance of the rechargeable battery.

During the application of high-rate current (when a large current is charged or discharged), a larger amount of the electrolyte solution flows out of the positive electrode mixture than the negative electrode mixture. Thus, for example, as described in Japanese Laid-Open Patent Publication Nos. 2017-174648, 2017-10882, 2017-123236, and 2016-66461, when the flow-out amount of the electrolyte solution is balanced between the positive and negative electrodes, degradation in the charging/discharging performance resulting from application of high-rate current will be limited.

### SUMMARY

Research has been continuously conducted to improve the performance of rechargeable batteries used in electric vehicles and the like, which require high-level battery performance qualities. Accordingly, there is a need for reducing the above-described effect of high-rate current application on the charging/discharging performance of the rechargeable batteries to improve the characteristic during high-rate current application (high-rate characteristic).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a rechargeable battery includes an electrode body formed by rolling a stack of a positive electrode sheet and a negative electrode sheet with a separator arranged in between. The positive electrode sheet and the negative electrode sheet each include an electrode mixture layer formed on a substrate that serves as a current collector. When a pressure is applied for a predetermined time to the electrode mixture layer, rolled together with the positive electrode sheet or the negative electrode sheet and impregnated with an electrolyte solution, a weight of the electrolyte solution that flows out of the electrode mixture layer per unit volume of the electrode mixture layer per unit pressure applied to the electrode mixture layer is referred to as a fluidity index value of the electrolyte solution. The predetermined time for which the electrode mixture layer is pressed is set to three minutes. The fluidity index value of the electrolyte solution is expressed as “gram (@three minutes) per kilopascal-cubic millimeter”. A value obtained by subtracting the fluidity index value of a negative mixture layer from the fluidity index value of a positive mixture layer is greater than or equal to 0.48×10\hat{ }-6.

In the rechargeable battery, the fluidity index value of the positive mixture layer may be in a range of 7.8×10\hat{ }-7 to 8.8×10\hat{ }-6.

In the rechargeable battery, the positive mixture layer may have a thickness in a range of 0.034 millimeters to 0.050 millimeters.

In the rechargeable battery, the fluidity index value of the negative mixture layer may be in a range of 2.4×10\hat{ }-6 to 1.1×10\hat{ }-5.

In the rechargeable battery, the negative mixture layer may have a thickness in a range of 0.060 millimeters to 0.080 millimeters.

In the rechargeable battery, the positive mixture layer may include a conductive fibrous carbon material.

Other features and aspects will be apparent from the following detailed description, the drawings, and the claims.

### BRIEF DESCRIPTION OF THE DRAWINGS

FIG. 1 is a perspective view of a rechargeable battery.

FIG. 2 is an exploded view of an electrode body.

FIG. 3 is a side view of the rechargeable battery.

FIG. 4 is a diagram schematically showing the structure of a positive mixture layer in the rechargeable battery of the present embodiment.

FIG. 5 is a diagram schematically showing the structure of a positive mixture layer in a rechargeable battery of a reference example.

FIG. 6 is a diagram schematically showing the arrangement of positive and negative electrodes and a separator.

FIG. 7 is a diagram illustrating a step of preparing a sample used for measurement of a liquid flow amount.

FIG. 8 is a diagram illustrating the step of preparing the sample used for measurement of the liquid flow amount.

FIG. 9 is a diagram illustrating a method for measuring the liquid flow amount.

FIG. 10 is a flowchart illustrating the method for measuring the liquid flow amount of an electrolyte solution.

FIG. 11 is a diagram illustrating the method for measuring the liquid flow amount.

FIG. 12 is a diagram illustrating the distribution of lithium ions in a rechargeable battery of a reference example in a state in which no current is applied.

FIG. 13 is a diagram illustrating the distribution of lithium ions in the rechargeable battery of the reference example in a state in which high-rate current is applied.

FIG. 14 is a diagram illustrating the distribution of lithium ions in the rechargeable battery of the reference example in a state in which high-rate current is applied.

FIG. 15 is a diagram illustrating the distribution of lithium ions in the rechargeable battery of the present embodiment in a state in which no current is applied.

FIG. 16 is a diagram illustrating the distribution of lithium ions in the rechargeable battery of the present embodiment in a state in which high-rate current is applied.

FIG. 17 is a diagram illustrating the distribution of lithium ions in the rechargeable battery of the present embodiment in a state in which high-rate current is applied.

FIG. 18 is a table showing effects of the liquid flow amount on a high-rate characteristic of the rechargeable battery with respect to positive and negative mixture layers.

FIG. 19 is a graph showing the effects of the liquid flow amount on the high-rate characteristic of the rechargeable battery with respect to the positive and negative mixture layers.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

An embodiment of a rechargeable battery having an electrode body will now be described with reference to the drawings.

### Rechargeable Battery

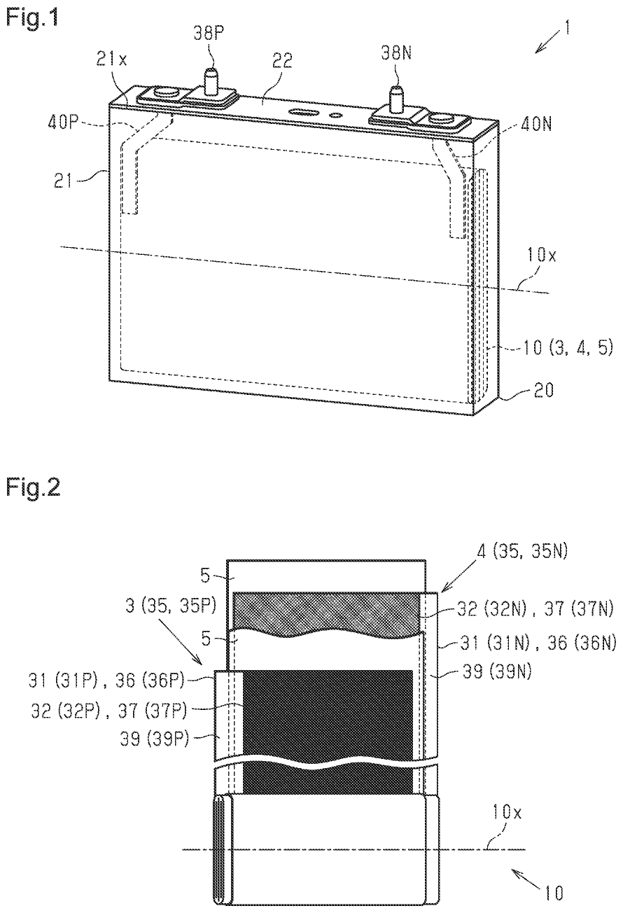

As shown in FIG. 1, a rechargeable battery 1 includes an electrode body 10 and a case 20. A positive electrode 3, a negative electrode 4, and separators 5 are integrated into the electrode body 10. The case 20 accommodates the electrode body 10. The rechargeable battery 1 of the present embodiment is a lithium-ion rechargeable battery in which the electrode body 10 inside the case 20 is impregnated with a non-aqueous electrolyte solution (not shown).

Specifically, sheets of the positive electrode 3, the negative electrode 4, and the separator 5 are stacked in the rechargeable battery 1. The stack of the positive electrode 3, the negative electrode 4, and the separators 5 is rolled to form the electrode body 10 in which the positive electrode 3, the negative electrode 4, and the separator 5 are alternately arranged with the separator 5 held in between in a radial direction.

Further, the case 20 includes a flat box-shaped case body 21 and a lid 22 that closes an open end 21x of the case body 21. The electrode body 10 has a flattened shape in correspondence with the box shape of the case 20.

### Electrode Sheet and Electrode Body

As shown in FIG. 2, in the rechargeable battery 1 of the present embodiment, the positive electrode 3 and the negative electrode 4 each include an electrode sheet 35. The electrode sheet 35 includes a sheet-shaped current collector 31 and an electrode mixture layer 32 formed on the current collector 31.

Specifically, in an electrode sheet 35P of the positive electrode 3, a mixture paste 37P is applied to a substrate 36P. The mixture paste 37P includes a lithium transition metal oxide and serves as a positive active material. The substrate 36P is formed from aluminum or the like and forms a positive current collector 31P. In an electrode sheet 35N of the negative electrode 4, a slurry of a mixture paste 37N is applied to a substrate 36N. The mixture 37N includes a carbon-based material and serves as a negative active material. The substrate 36N is formed from copper or the like and forms a negative current collector 31N. A binder is included in each of the mixture pastes 37P and 37N. The mixture pastes 37P and 37N are dried so that a positive mixture layer 32P and a negative mixture layer 32N are formed on the positive and negative electrode sheets 35P and 35N, respectively. Thus, the positive mixture layer 32P is referred to as the electrode mixture layer 32 of the positive electrode sheet 35P. Also, the negative mixture layer 32N is referred to as the electrode mixture layer 32 of the negative electrode sheet 35N.

The positive and negative electrode sheets 35P and 35N are shaped as strips. In the electrode body 10, the positive and negative electrode sheets 35P and 35N are stacked with the separator 5 held in between and rolled about a rolling axis 10x that extends in a widthwise direction of the strips (sideward direction in FIG. 2).

In FIG. 2, the separators 5 and the electrode sheets 35 are rolled with the electrode sheet 35P of the positive electrode 3 arranged at the inner side. However, this is merely an example of the structure of the electrode body 10. The separators 5 and the electrode sheets 35 may be rolled with the electrode sheet 35N of the negative electrode 4 arranged at the inner side. Such arrangement determines whether the outermost electrode sheet 35 of the electrode body 10 will be the electrode sheet 35P of the positive electrode 3 or the electrode sheet 35N of the negative electrode 4.

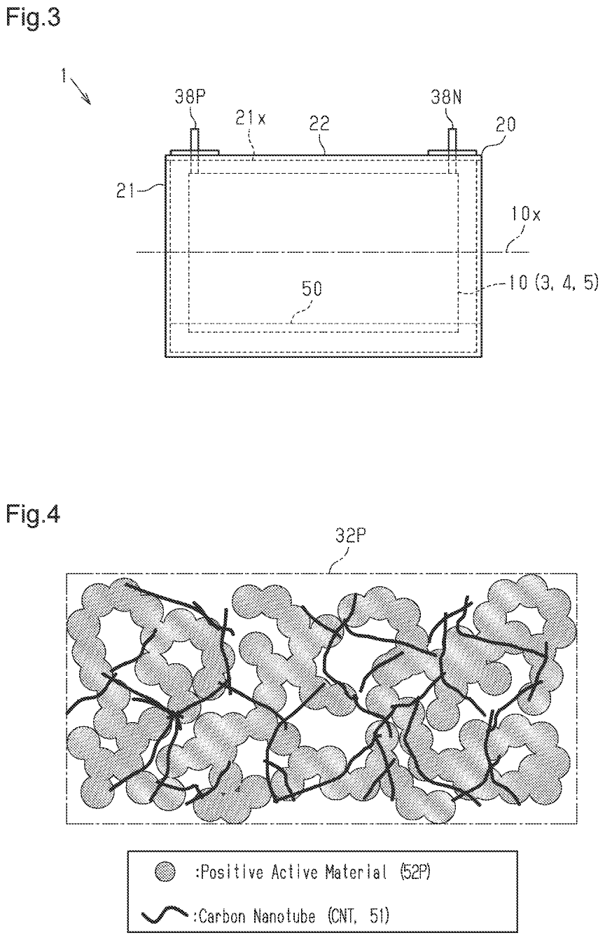

As shown in FIGS. 1 to 3, the lid 22 of the case 20 includes a positive terminal 38P and a negative terminal 38N projecting out of the case 20. Further, each electrode sheet 35 includes an uncoated portion 39 where the electrode mixture layer 32 is not formed on the current collector 31. The uncoated portions 39 electrically connect the electrode sheet 35P of the positive electrode 3 to the positive terminal 38P and the electrode sheet 35N of the negative electrode 4 to the negative terminal 38N.

Specifically, the electrode body 10 is accommodated in the case 20 in a state in which the rolling axis 10x of the electrode body 10 is parallel to a longitudinal direction (sideward direction in FIG. 1) of the lid 22 that has the form of a substantially elongated rectangular plate. Further, in such a state, a connector 40P connects the uncoated portion 39P of the electrode sheet 35P of the positive electrode 3 to the positive terminal 38P. In the same manner, a connector 40N connects the uncoated portion 39N of the electrode sheet 35N of the negative electrode 4 to the negative terminal 38N.

An electrolyte solution 50 is injected into the case 20. The electrolyte solution 50 is formed by dissolving lithium salt, serving as a supporting electrolyte, in an organic solvent. This impregnates the electrode body 10 in the case 20 with the electrolyte solution 50.

### High-Rate Characteristic

As shown in FIG. 4, the positive mixture layer 32P of the electrode body 10 includes carbon nanotubes CNT serving as a conductive fibrous carbon material 51. Specifically, the carbon nanotubes CNT are applied to the substrate 36P of the positive electrode 3 together with the positive active material 52P in the state of the mixture paste 37P (refer to FIG. 2). Thus, the carbon nanotubes CNT dispersed in the positive mixture layer 32P act as a conductive material that forms conductive paths of the positive active material 52P located near the carbon nanotubes CNT.

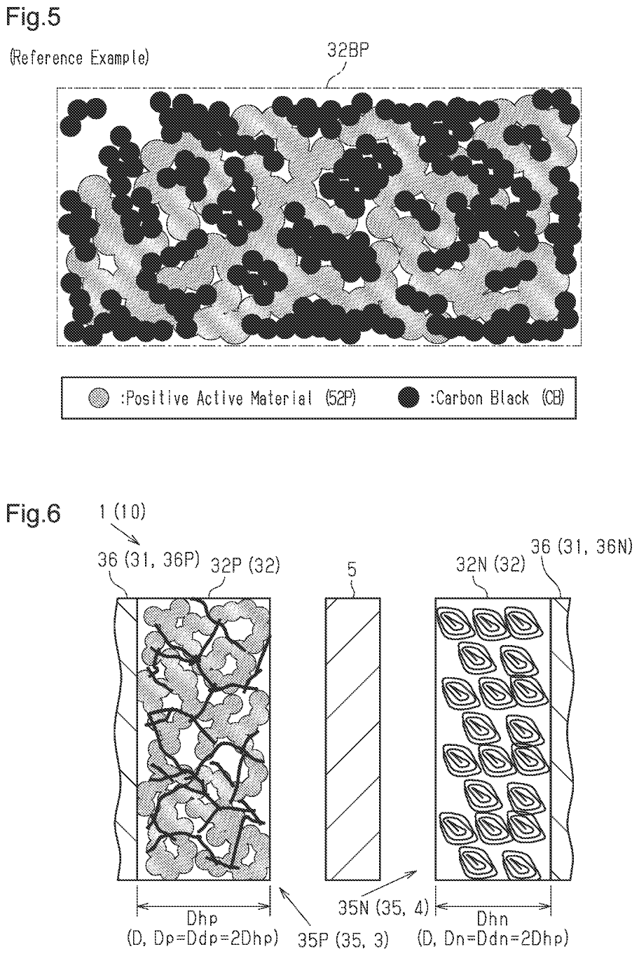

As shown in the reference example of FIG. 5, when a positive mixture layer 32BP includes a granular conductive material, such as carbon black CB, and the positive mixture layer 32BP has a dense structure. This would lower the fluidity of the electrolyte solution 50 in the positive mixture layer 32BP.

In contrast, as shown in FIG. 4, the fibrous carbon nanotubes CNT form a large number of fine pores in the positive mixture layer 32P. Thus, the electrolyte solution 50 in the positive mixture layer 32P has a high fluidity.

As shown in FIG. 6, the positive mixture layer 32P of the positive electrode 3 has a thickness Dp and the negative mixture layer 32N of the negative electrode 4 has a thickness Dn. Further, the positive mixture layer 32P and the negative mixture layer 32N each have a fluidity index value indicating the fluidity of the electrolyte solution 50 therein. The rechargeable battery 1 of the present embodiment controls the thicknesses Dp and Dn of the positive mixture layer 32P and the negative mixture layer 32N and the fluidity index values of the electrolyte solution 50 so as to improve the high-rate characteristic of the rechargeable battery 1.

More specifically, the rechargeable battery 1 of the present embodiment has a double-side stacking structure, in which the electrode mixture layer 32 is formed on two opposite surfaces of the sheet-shaped substrate 36 for a corresponding one of the positive and negative electrode sheets 35. Accordingly, in the electrode sheet 35P of the positive electrode 3, the positive mixture layer 32P formed on one surface of the substrate 36 has a single-surface thickness Dhp of the positive mixture layer 32P. In the electrode sheet 35N of the negative electrode 4, the negative mixture layer 32N formed on one surface of the substrate 36 has a single-surface thickness Dhn of the negative mixture layer 32N. Further, the values obtained by doubling the single-surface thicknesses Dhp and Dhn respectively correspond to a double-surface thickness Ddp of the positive mixture layer 32P and a double-surface thickness Ddn of the negative mixture layer 32N, or the combined thickness of the electrode mixture layer 32 formed on the two opposite surfaces of the substrate 36. In the present embodiment, the double-surface thicknesses Ddp and Ddn are controlled as the thickness Dp of the positive mixture layer 32P and the thickness Dn of the negative mixture layer 32N, respectively.

Specifically, the thickness Dp of the positive mixture layer 32P is controlled by adjusting the carbon nanotubes CNT that serve as the conductive material, the pressing pressure and coating speed like at which the mixture paste 37P is applied to the substrate 36P, and the like.

In the rechargeable battery 1 of the present embodiment, the carbon nanotubes CNT have, for example, a specific surface area value, measured by a Brunauer-Emmett-Teller (BET) method, in a range of 150 to 300. The BET specific surface area values are expressed as “square meter per gram” (m\hat{ }2/g). The pressing pressure is, for example, set to a range of 40 kN to 100 kN. The coating speed is, for example, set to a range of 6 m per minute to 120 m per minute. This controls the thickness Dp of the positive mixture layer 32P, for example, in a range of 0.034 mm to 0.050 mm.

Further, the thickness Dn of the negative mixture layer 32N is controlled by adjusting a binder and a thickener that are added to the mixture paste 37N together with the carbon-based material such as graphite and the like, the pressing pressure and coating speed at which the mixture paste 37N is applied to the substrate 36N, and the like.

The binder added to the mixture paste 37N includes, for example, styrene-butadiene rubber (SBR), styrene acrylic rubber (SAR), and/or the like. The thickener includes carboxy methyl cellulose (CMC) and/or the like.

The pressing pressure is, for example, set to a range of 10 kN to 50 kN. The coating speed is, for example, set to a range of 6 m per minute to 120 m per minute. This controls the thickness Dn of the negative mixture layer 32N, for example, in a range of 0.060 mm to 0.080 mm.

In addition to the thicknesses Dp and Dn, density and porosity of the positive and negative mixture layers 32P and 32N are also controlled. The density of the positive mixture layer 32P is, for example, controlled in a range of 2.2 g/cc to 2.9 g/cc. The density of the negative mixture layer 32N is, for example, controlled in a range of 0.9 g/cc to 1.2 g/cc. The porosity of the positive mixture layer 32P is, for example, controlled in a range of 37% to 51%. The porosity of the negative mixture layer 32N is, for example, controlled in a range of 45% to 55%.

The electrolyte solution 50 of the present embodiment includes, for example, ethylene carbonate (EC), ethyl methyl carbonate (EMC), dimethyl carbonate (DMC), and the like. The composition ratios are, for example, set to satisfy EC=1, 1≤EMC≤1.5, and 1≤DMC≤1.5. In this case, the electrolyte solution 50 has a specific gravity in a range of 1.1 to 1.3. The electrolyte solution 50 has a viscosity in accordance with the above composition.

In the rechargeable battery 1 of the present embodiment, a liquid flow amount Q is used as the fluidity index value of the electrolyte solution 50 in the electrode mixture layer 32. More specifically, when pressure is applied for a predetermined time to the electrode mixture layer 32, rolled together with the electrode sheet 35, the liquid flow amount Q indicates a weight of the electrolyte solution 50 that flows out of the electrode mixture layer 32 per unit volume per unit pressure applied to the electrode mixture layer 32. Further, the predetermined time for which pressure is applied to the electrode mixture layer 32 is set to three minutes, and the liquid flow amount Q is expressed as “gram (@three minutes) per kilopascal-cubic millimeter”, or “g (@3 min)/kPa×mm\hat{ }3”. In this manner, a liquid flow amount Qp of the positive electrode 3 has a value in a range of 7.8×10\hat{ }-7 to 8.8×10\hat{ }-6. The component “10\hat{ }-7” represents “ten to the power of negative seven”, and the component “10\hat{ }-6” represents “ten to the power of negative six” (same applies to the description hereafter). A liquid flow amount Qn of the negative electrode 4 has a value in a range of 2.4×10\hat{ }-6 to 1.1×10\hat{ }-5.

More specifically, as indicated by the following inequality, the rechargeable battery 1 of the present embodiment is configured such that the liquid flow amount Q, serving as the fluidity index value of the electrolyte solution 50 that impregnates the electrode mixture layer 32, is greater at the side of the positive electrode 3 than the side of the negative electrode 4.

$$Qp > Qn \qquad ( 1 )$$

Specifically, it is preferred that the value obtained by subtracting the liquid flow amount Qn at the negative electrode 4 from the liquid flow amount Qp at the positive electrode 3 satisfies the following inequality (2).

$$Qp - Qn \geq 0.48 \times 1 {0}^{∧} - 6 \qquad ( 2 )$$

It is further preferred that the value obtained by subtracting the liquid flow amount Qn at the negative electrode 4 from the liquid flow amount Qp at the positive electrode 3 satisfies the following inequality (3).

$$Qp - Qn \geq 0.66 \times {10}^{∧} - 6 \qquad ( 3 )$$

This improves the high-rate characteristic of the rechargeable battery 1.

### Method for Measuring Liquid Flow Amount

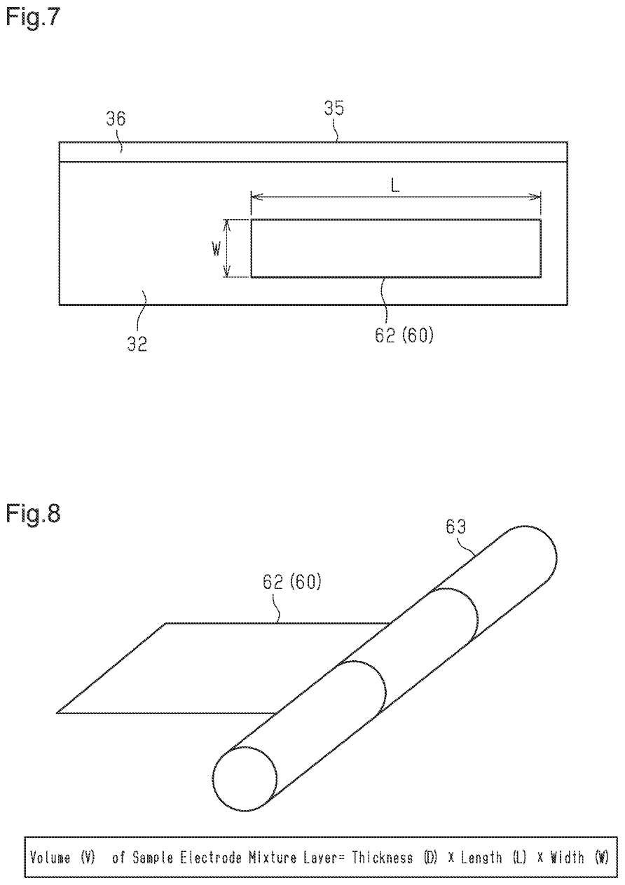

As shown in FIGS. 7 and 8, when measuring the liquid flow amount Q, a sample 60 for measurement is prepared from each of the positive and negative electrode sheets 35 in the electrode body 10 of the rechargeable battery 1.

Specifically, a strip-shaped sample sheet 62 is cut out of the actual electrode sheet 35. The sample sheet 62 has a predetermined length L and a predetermined width W. Then, the sample sheet 62 is wound around a rod 63, and the rolled sample sheet 62 is fixed with a tape (not shown). In this state, the rod 63 is removed from the sample sheet 62. This forms the measurement sample 60 having a structure of a rolled body in the same manner as the electrode body 10 of the rechargeable battery 1.

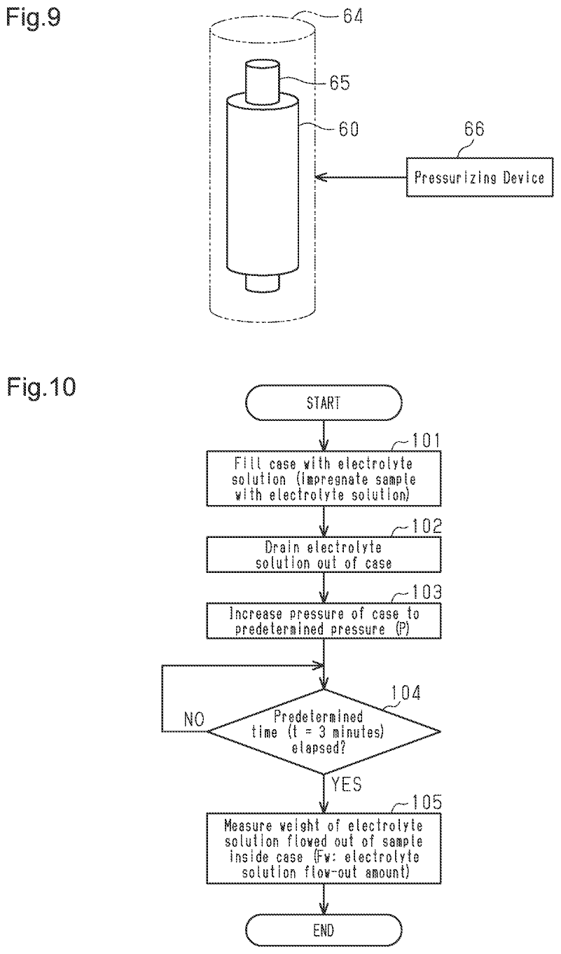

As shown in FIG. 9, the above-described sample 60 is arranged in a measurement case 64 that is a sealed container. In this state, a pressure P is applied to the sample 60 for a predetermined time, and then the weight of the electrolyte solution 50 that flowed out of the electrode mixture layer 32 is measured.

Specifically, as shown in FIG. 10, the case 64 accommodating the sample 60 is filled with the electrolyte solution 50 such that the sample 60, more specifically, the electrode mixture layer 32 is impregnated with the electrolyte solution 50 (step 101). For example, a rod-shaped rubber plug 65 is inserted into the hollow of the sample 60 that is formed when the rod 63 is removed and seals the hollow in a liquid-tight manner. Next, the electrolyte solution 50 is drained out of the case 64 such that only the sample 60, impregnated with the electrolyte solution 50, remains in the case 64 (step 102). In this state, a pressurizing device 66 connected to the case 64 is used to increase the pressure of the case 64 to a predetermined pressure P (step 103).

Then, the pressurized state is maintained for a predetermined time t (step 104: NO). As described above, in the rechargeable battery 1 of the present embodiment, the predetermined time t is three minutes. After the predetermined time t has elapsed (step 104: YES), the weight of the electrolyte solution 50 collected in the case 64, that is, the weight of the electrolyte solution 50 flowed out of the sample 60 through the pressurization, is measured as an electrolyte solution flow-out amount FW (step 105). The electrolyte solution flow-out amount FW measured in step 105 is used to calculate a liquid flow amount Qs for each sample 60.

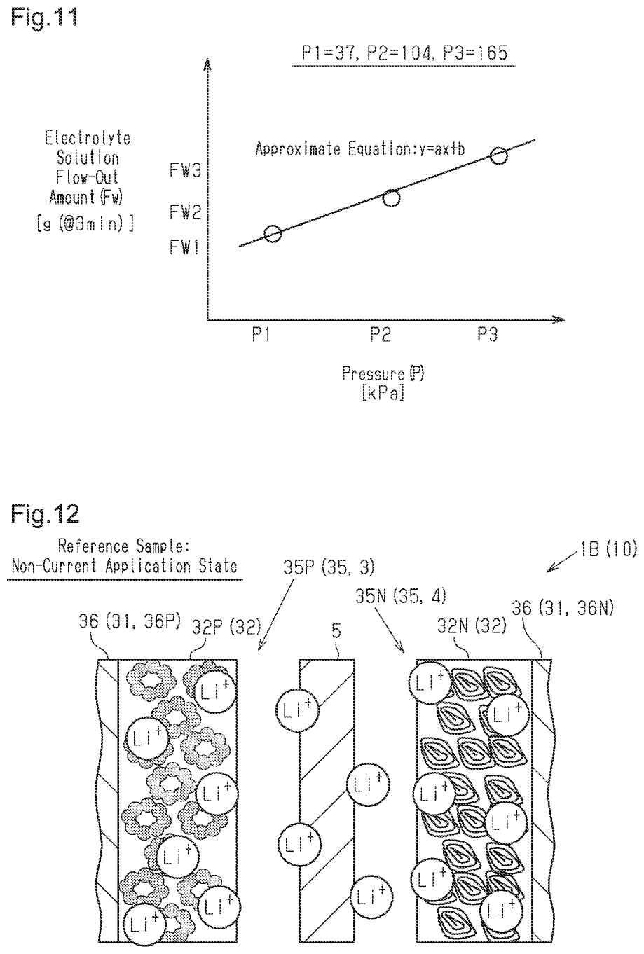

More specifically, as shown in FIG. 11, various predetermined pressures P are applied to the sample 60 in the case 64 to measure electrolyte solution flow-out amounts FW resulting from the above-described pressurization. The electrolyte solution flow-out amount FW is, for example, measured at each of a first predetermined pressure P1 of 37 kPa, a second predetermined pressure P2 of 104 kPa, a third predetermined pressure P3 of 165 kPa. For example, the pressurization measurement is sequentially performed from the lowest one of the predetermined pressures P1, P2, and P3 for three minutes each without changing the sample 60. Subsequently, electrolyte solution flow-out amounts Fw1, Fw2, and Fw3 are respectively obtained for the predetermined pressures P1, P2, and P3 and plotted on the X-Y coordinates in association with the predetermined pressures P1, P2, and P3.

The electrolyte solution flow-out amount FW, which is the weight of the electrolyte solution 50 flowed out of the sample 60 through the pressurization, corresponds to the predetermined pressure P applied to the sample 60. Thus, a linear approximate equation (y=ax+b) is obtained from the measurement results plotted on the X-Y coordinates. Then, the liquid flow amount Qs for each sample 60 that is expressed as “g (@3 min)/kPa” is calculated from the inclination of the linear approximate equation.

As shown in FIGS. 7 and 8, the volume V of the electrode mixture layer 32 in the sample 60 is determined by the length L and the width W of the sample sheet 62 of the sample 60 and the thickness D of the electrode mixture layer 32, as indicated by the following equation.

$$V = D \times L \times W \qquad ( 4 )$$

In the rechargeable battery 1 of the present embodiment, the length L of the sample sheet 62 is set to 500 mm, and the width W is set to 55 mm. Further, as described above, the liquid flow amount Q, serving as the fluidity index value of the electrolyte solution 50 in the electrode mixture layer 32 of the electrode body 10, is expressed as “gram (@three minutes) per kilopascal-cubic millimeter”. Specifically, the liquid flow amount Q is a value indicating the weight of the electrolyte solution 50 flowed out from the electrode mixture layer 32 per unit volume per unit pressure when the pressure P is applied for the predetermined time t to the electrode mixture layer 32 rolled together with the electrode sheet 35. Therefore, the liquid flow amount Q is obtained by dividing the liquid flow amount Qs of each sample 60 by the volume V of the electrode mixture layer 32 of the sample 60, as indicated by the following equation.

$$Q = Qs / V \qquad ( 5 )$$

In this manner, the steps shown in FIGS. 7 to 11 are performed to measure the liquid flow amount Q that serves as the fluidity index value of the electrolyte solution 50 in the electrode mixture layer 32 of the electrode body 10.

### Operation

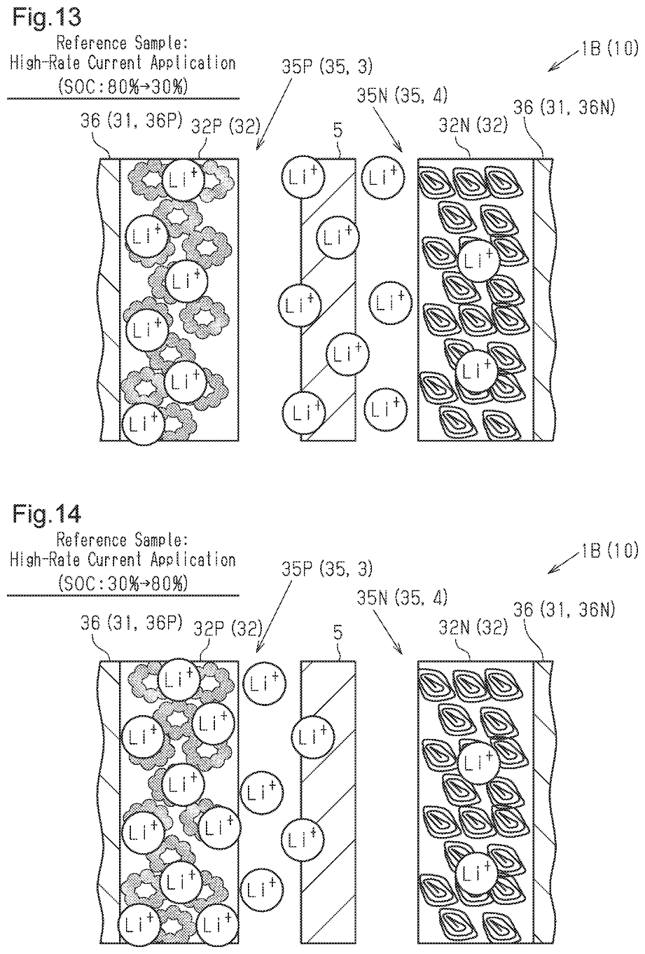

As shown in the reference example of a rechargeable battery 1B in FIGS. 12 to 14, during application of high-rate current, the salt concentration of the electrolyte solution 50 has a tendency of becoming uneven between the positive electrode 3 and the negative electrode 4. Specifically, during high-rate discharging shown in FIG. 13, the lithium ion concentration is likely to become relatively high at the side of the negative electrode 4. Further, during high-rate charging shown in FIG. 14, the lithium ion concentration is likely to become relatively low at the side of the negative electrode 4. Such unevenness in the salt concentration may increase the internal resistance and degrade the charging/discharging performance.

In this respect, the rechargeable battery 1 of the present embodiment controls the thickness Dp of the positive mixture layer 32P and the thickness Dn of the negative mixture layer 32N of the electrode body 10, as described above. Further, the rechargeable battery 1 of the present embodiment also controls the liquid flow amounts Qp and Qn, serving as the liquid fluidity index values of the electrolyte solution 50, with respect to the positive mixture layer 32P and the negative mixture layer 32N.

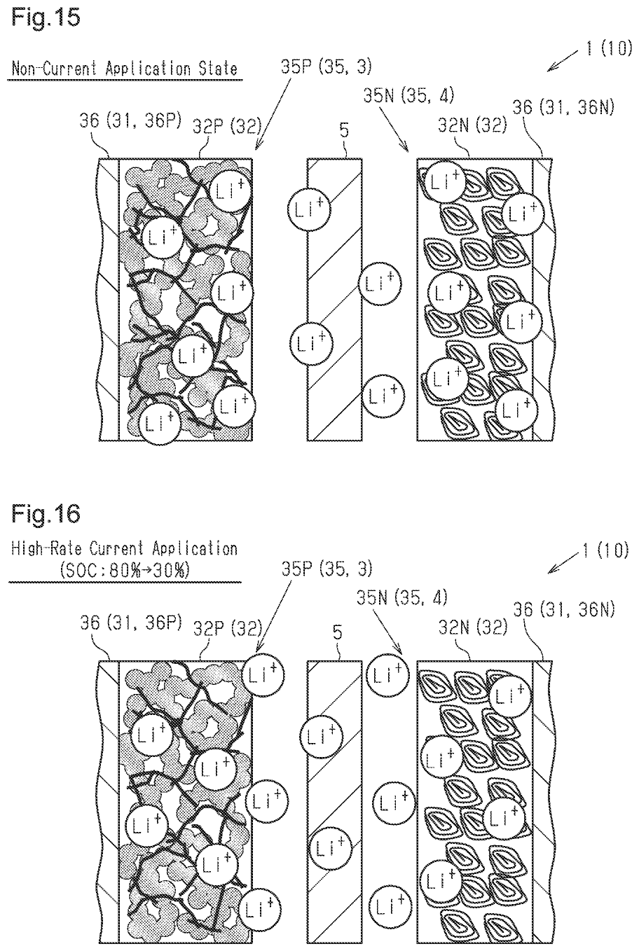

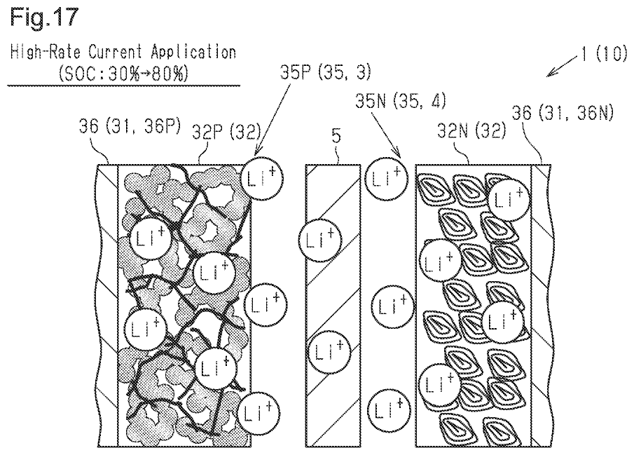

As a result, as shown in FIGS. 15 to 17, even during application of high-rate current, the salt concentration of the electrolyte solution 50 is unlikely to become uneven between the positive electrode 3 and the negative electrode 4. This limits degradation of charging/discharging performance of the rechargeable battery 1 that results from application of high-rate current.

The present embodiment has the following advantages.
(1) The rechargeable battery 1 includes the electrode body 10 formed by rolling a stack of the electrode sheet 35P for the positive electrode 3 and the electrode sheet 35N for the negative electrode 4 with the separator 5 arranged in between. The electrode sheets 35P and 35N each include the electrode mixture layer 32 formed on the substrate 36 of the current collector 31. When the pressure P is applied for the predetermined time t to the electrode mixture layer 32, rolled together with the electrode sheet 35, the weight of the electrolyte solution 50 flowed out of the electrode mixture layer 32 per unit volume per unit pressure applied to the electrode mixture layer 32 is referred to as the liquid flow amount Q. The liquid flow amount Q serves as the fluidity index value of the electrolyte solution 50, with which the electrode mixture layer 32 is impregnated. The predetermined time t for which the pressure P is applied to the electrode mixture layer 32 is to set to three minutes, and the liquid flow amount Q is expressed as “gram (@three minutes) per kilopascal-cubic millimeter”. The rechargeable battery 1 is configured so that the value obtained by subtracting the liquid flow amount Qn at the negative mixture layer 32N from the liquid flow amount Qp at the positive mixture layer 32P (Qp−Qn) is greater than or equal to 0.48×10\hat{ }-6.

This configuration reduces the variation in the salt concentration of the electrolyte solution 50 in the electrode body 10 that occurs due to application of high-rate current. Consequently, the high-rate characteristic of the rechargeable battery 1 is improved.
(2) The liquid flow amount Qp with respect to the positive mixture layer 32P is in a range of 7.8×10\hat{ }-7 to 8.8×10\hat{ }-6. The thickness Dp of the positive mixture layer 32P is in a range of 0.034 millimeters to 0.050 millimeters. Further, the liquid flow amount Qn with respect to the negative mixture layer 32N is in a range of 2.4×10\hat{ }-6 to 1.1×10\hat{ }-5. The thickness Dn of the negative mixture layer 32N is in a range of 0.060 millimeters to 0.080 millimeters. This effectively improves the high-rate characteristic of the rechargeable battery 1.
(3) The positive mixture layer 32P includes the carbon nanotubes CNT, serving as the conductive fibrous carbon material 51.

The fibrous carbon nanotubes CNT form a large number of fine pores in the positive mixture layer 32P. This ensures a high fluidity of the electrolyte solution 50 in the positive mixture layer 32P.

The above embodiment may be modified as described below. The above embodiment and the following modifications can be combined as long as the combined modifications remain technically consistent with each other.

In the above embodiment, the rechargeable battery 1 of the present embodiment has a double-side stacking structure, in which the electrode mixture layer 32 is formed on two opposite surfaces of the sheet-shaped substrate 36 for a corresponding one of the positive and negative electrode sheets 35. Thus, the double-surface thicknesses Ddp and Ddn of the positive mixture layer 32P and the negative mixture layer 32N correspond to the thickness Dp of the positive mixture layer 32P and the thickness Dn of the negative mixture layer 32N, respectively. However, there is no limit to such a configuration. the rechargeable battery 1 may have a single-side stacking structure in which the electrode mixture layer 32 is formed only on one side of the substrate 36 for a corresponding one of the positive and negative electrode sheets 35. In this case, the single-surface thickness Dhp of the positive mixture layer 32P and the single-surface thickness Dhn of the negative mixture layer 32N may be used as the thickness Dp and Dn of the positive mixture layer 32P and the negative mixture layer 32N, respectively.

In the above embodiment, the liquid flow amount Q, serving as the fluidity index value of the electrolyte solution 50, is expressed as “gram (@three minutes) per kilopascal-cubic millimeter”, or “g (@3 min)/kPa×mm\hat{ }3”. In this case, the liquid flow amount Qp with respect to the positive mixture layer 32P has a value in a range of 7.8×10\hat{ }-7 to 8.8×10\hat{ }-6. The liquid flow amount Qn with respect to the negative mixture layer 32N has a value in a range of 2.4×10\hat{ }-6 to 1.1×10\hat{ }-5. Further, the thickness Dp of the positive mixture layer 32P is in a range of 0.034 mm to 0.050 mm. The thickness Dn of the negative mixture layer 32N is in a range of 0.060 mm to 0.080 mm. However, there is no limit to such a configuration, and these values may be changed as long as the relationship of above inequality (2) is satisfied. Preferably, the relationship of above inequality (3) is also satisfied.

Furthermore, depending on the requested level of the high-rate characteristic, the above value ranges may be expanded to extents that satisfy the relationship of above inequality (1). In other words, the above value ranges may be expanded as long as the electrolyte solution 50 in the electrode mixture layer 32 has a greater fluidity index value at the positive electrode 3 than the negative electrode 4. In this case, for example, the fluidity index value does not have to be the above-described liquid flow amount Q, and may use an index value including the concept of the speed at which the electrolyte solution 50 flows out of the electrode mixture layer 32.

The densities and the porosities of the positive mixture layer 32P and the negative mixture layer 32N may be changed. The pressing pressure, speed, and the like at which the mixture paste 37 is applied to the substrate 36 may be changed. The conductive material, binder, and thickener may be changed.

In the embodiment, the positive mixture layer 32P includes the carbon nanotubes CNT, serving as the conductive fibrous carbon material 51. However, there is no limit to such a configuration, and the positive mixture layer 32P may include other type of a conductive fibrous carbon material, such as carbon nanofibers (CNF), as the conductive material. Further, other specifications of the conductive fibrous carbon material 51, such as the BET specific surface area value, may be changed. The positive mixture layer 32P does not necessarily have to include such a conductive fibrous carbon material 51.

In the above embodiment, the sample 60 used for measurement of the liquid flow amount Q is formed from the sample sheet 62 having the length L of 500 mm and the width W of 55 mm. However, there is no limit to such a structure, and the sample sheet 62 may have any size. In other words, the volume V of the electrode mixture layer 32 in the sample 60 formed from the sample sheet 62 may be changed.

In the embodiment, when measuring the liquid flow amount Q, the pressure is applied to the electrode mixture layer 32 for the predetermined time t, which is set to three minutes, and the weight of the electrolyte solution 50 that flowed out of the sample 60 through pressurization is measured as the electrolyte solution flow-out amount FW. However, the predetermined time t may be changed.

In the above embodiment, the electrolyte solution flow-out amount FW is measured at each of the first predetermined pressure P1 of 37 kPa, the second predetermined pressure P2 of 104 kPa, and the third predetermined pressure P3 of 165 kPa. The electrolyte solution flow-out amounts Fw1, Fw2, and Fw3 are respectively obtained for the predetermined pressures P1, P2, and P3 and plotted on the X-Y coordinates in association with the predetermined pressures P1, P2, and P3 to calculate the liquid flow amount Qs for each sample 60. However, there is no limit to such a configuration, and the pressurization measurement of the electrolyte solution flow-out amount FW may be performed twice or four times or more. In this case, the pressure P applied to the electrode mixture layer 32 of the sample 60 may be changed each time.

In the embodiment, the rechargeable battery 1 is a lithium-ion rechargeable battery. However, there is no limit to such a configuration, and the above embodiment may be applied to a rechargeable battery 1 that is not a lithium-ion rechargeable battery.

The shapes of the positive terminal 38P and the negative terminal 38N are not limited to those shown in FIG. 1 and may be changed. The shape of the case 20 that defines the shape of the rechargeable battery 1 is not limited to the form of a flat box and may be, for example, cylindrical.

A Technical concept that can be understood from the above embodiment and the modified examples will now be described.
(a) An electrode body formed by rolling a stack of positive and negative electrode sheets with a separator held in between in which, each electrode sheet includes an electrode mixture layer formed on a substrate that serves as a current collector, the electrode mixture layer is impregnated with an electrolyte solution, and the electrolyte solution has a greater fluidity index value at a positive electrode than a negative electrode.

### EXAMPLES

Examples of the present disclosure will now be described in order to illustrate specific configurations and advantages of the present disclosure. However, the present disclosure is not limited to these examples.

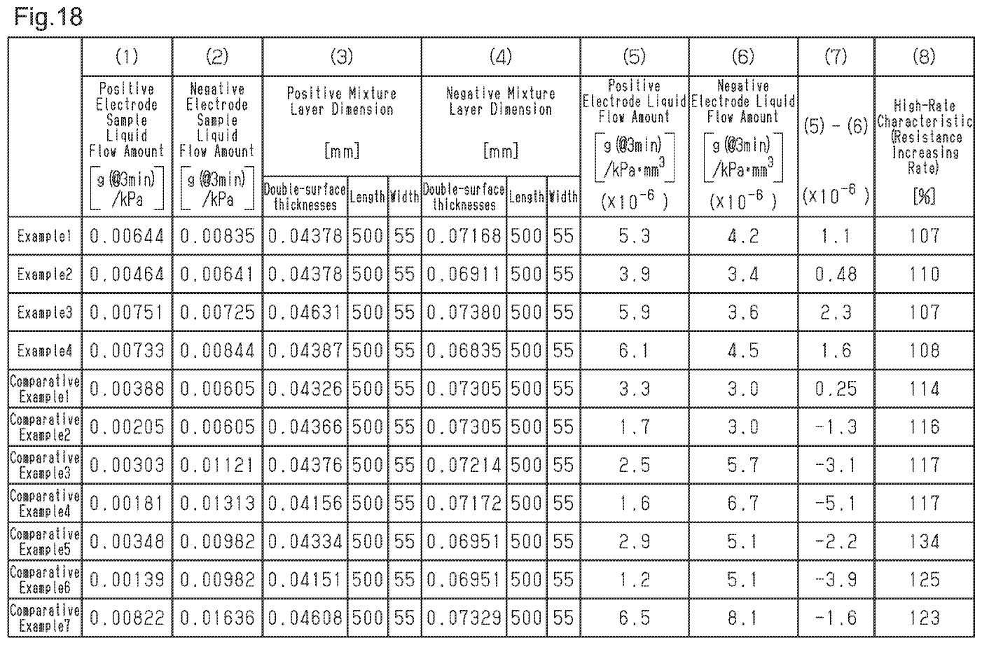

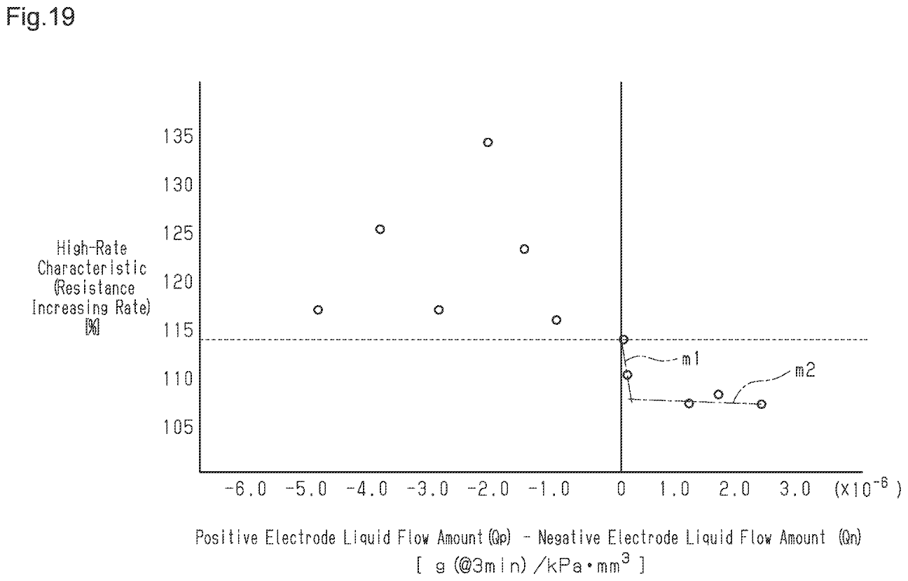

FIGS. 18 and 19 are a table and a graph that show test results regarding the effect of the liquid flow amounts Qp and Qn on the high-rate characteristic of the rechargeable battery 1 with respect to the positive and negative mixture layers 32P and 32N of the electrode body 10.

Columns (1) and (2) of the table show a liquid flow amount Qsp at the positive electrode 3 and a liquid flow amount Qsn at the negative electrode 4 for each sample 60, respectively. In this characteristic test, the liquid flow amounts Qsp and Qsn for each sample 60 in Examples 1 to 4 and Comparative Examples 1 to 7 were measured through above-described method. Accordingly, in columns (1) and (2), the liquid flow amounts Qsp and Qsn for each sample 60 is expressed as “g (@3 min)/kPa”.

The electrode mixture layer 32 of each sample 60 in Examples 1 to 4 and Comparative Examples 1 to 7 had thicknesses Dp and Dn. Columns (3) and (4) of the table include the thickness Dp of the positive mixture layer 32P and the thickness Dn of the negative mixture layer 32N that correspond to the double-surface thicknesses Ddp and Ddn, respectively. Further, each sample 60 was formed by a sample sheet 62 having the length L of 500 mm and the width W of 55 mm. Therefore, as expressed by equation (4) in the above embodiment, the electrode mixture layer 32 of each sample 60 in Examples 1 to 4 and Comparative Examples 1 to 7 had a volume V that is in accordance with the difference in the thickness D. Columns (5) and (6) of the table show the liquid flow amounts Qp and Qn per unit volume that were obtained by dividing the liquid flow amounts Qsp and Qsn of each sample 60 by the volume V of the electrode mixture layer 32 of the corresponding sample 60 using the above equation (5). Accordingly, the liquid flow amounts Qp and Qn is expressed as “g (@3 min)/kPa×mm\hat{ }3”.

Column (7) of the table shows a value obtained by subtracting the value in column (6) from the value in column (5), or a value obtained by subtracting the liquid flow amount Qn at the negative electrode 4 from the liquid flow amount Qp at the positive electrode 3 (Qp−Qn). Column (8) of the table shows a resistance increasing rate that serves as an evaluation index of the high-rate characteristic. Specifically, the resistance increasing rate is an increasing rate (%) of the internal resistance (CD-IR) after a charging/discharging cycle test was performed for a certain period of time. In the charging/discharging test, a large current (dozens of amperes or more) was repeatedly charged and discharged, which corresponds to application of high-rate current. Therefore, as the high-rate characteristic value becomes smaller, degradation of the charge/discharge performance is reduced, in other words, the high-rate characteristic is more superior.

As shown in FIGS. 18 and 19, Examples 1 to 4 each had a positive value in column (7). Specifically, the value obtained by subtracting the liquid flow amount Qn at the negative electrode 4 from the liquid flow amount Qp at the positive electrode 3 was positive (Qp−Qn>0). In other words, when the liquid flow amounts Qp and Qn were compared, the positive electrode 3 had a larger value than the negative electrode 4 (Qp>Qn). Examples 1 to 4 had excellent resistance increasing rates (%) of 107, 110, 107, and 108, respectively.

In contrast, the value obtained by subtracting the liquid flow amount Qn at the negative electrode 4 from the liquid flow amount Qp at the positive electrode 3 was negative (Qp−Qn<0) in Comparative Examples 2 to 7, except for Comparative Example 1. In other words, when the liquid flow amounts Qp and Qn were compared, the positive electrode 3 had a smaller value than the negative electrode 4 (Qp<Qn). When the requested level of the resistance increasing rate (%) is 114, Comparative Examples 2 to 7 have a greater resistance increasing rate (%) than the requested level. This indicates that the improvement in the high-rate characteristic was insignificant. Comparative Example 1 had the value obtained by subtracting the liquid flow amount Qn at the negative electrode 4 from the liquid flow amount Qp at the positive electrode 3 that was slightly in the positive. However, the resistance increasing rate (%) was 114.

When Examples 1 to 4 are compared, Examples 1, 3, and 4 had a particularly excellent high-rate characteristic. Further, when Examples 1 to 4 are compared, Example 2 had the smallest value of 0.48×10\hat{ }-6 in column (7).

Therefore, the relationship of inequality (2), indicated as the preferred numerical range in the above embodiment, can be obtained based on the above test results. This confirms that “Qp−Qn≥0.48×10\hat{ }-6” is appropriate as the preferred numerical range when the liquid flow amount Q is expressed as “gram (@three minutes) per kilopascal-cubic millimeter”.

Further, when the value obtained by subtracting the liquid flow amount Qn at the negative electrode 4 from the liquid flow amount Qp at the positive electrode 3 is in the positive, the test results of Examples 1 to 4 indicate a point at which the improvement effect on the high-rate characteristic changes.

In FIG. 19, a supplemental line m1 is provided in accordance with a point indicating the test result of Example 2 and a point at which the resistance increasing rate (%) is 114 and the value obtained by subtracting the liquid flow amount Qn at the negative electrode 4 from the liquid flow amount Qp at the positive electrode 3 is 0. This shows a range in which the high-rate characteristic suddenly improves as the value obtained by subtracting the liquid flow amount Qn at the negative electrode 4 from the liquid flow amount Qp at the positive electrode 3 increases. Also, in FIG. 19, a supplemental line m2 is provided in accordance with points indicating the test results of Examples 1, 3, and 4. This shows a range in which the high-rate characteristic is superior. Furthermore, the intersecting point of the two supplemental lines m1 and m2 corresponds to a point at which the improvement effect of the high-rate characteristic changes. This point of change is located where the value obtained by subtracting the liquid flow amount Qn at the negative electrode 4 from the liquid flow amount Qp at the positive electrode 3 is 0.66×10\hat{ }-6 when the liquid flow amount Q is expressed as “gram (@three minutes) per kilopascal-cubic millimeter”.

Therefore, the relationship of inequality (3), indicated as the preferred numerical range in the above embodiment, can be obtained based on the above test results. This confirms that “Qp−Qn≥0.66×10\hat{ }-6” is appropriate as the preferred numerical range. When the requested level of the high-rate characteristics is relatively moderate, the preferred numerical range can be expanded to the range (Qp−Qn>0), corresponding to inequality (1) by excluding Comparative Example 1 as a measurement error.

In each of Examples 1 to 4, the liquid flow amount Qp at the positive electrode 3 was in a range of 7.8×10\hat{ }-7 to 8.8×10\hat{ }-6. In each of Examples 1 to 4, the thickness Dp of the positive mixture layer 32P was in a range of 0.034 mm to 0.050 mm. In each of Examples 1 to 4, the liquid flow amount Qn at the negative electrode 4 was in a range of 2.4×10\hat{ }-6 to 1.1×10\hat{ }-5. In each of Examples 1 to 4, the thickness Dn of the negative mixture layer 32N was in a range of 0.060 mm to 0.080 mm.

These confirm that the liquid flow amount Qp and the thickness Dp of the positive mixture layer 32P and the liquid flow amount Qn and the thickness Dn of the negative mixture layer 32N, described as preferred numerical values in the above embodiment, are appropriate.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rechargeable battery, comprising:
an electrode body formed by rolling a stack of a positive electrode sheet and a negative electrode sheet with a separator arranged in between, wherein:
the positive electrode sheet and the negative electrode sheet each include an electrode mixture layer formed on a substrate that serves as a current collector;
when a pressure is applied for a predetermined time to the electrode mixture layer, rolled together with the positive electrode sheet or the negative electrode sheet and impregnated with an electrolyte solution, a weight of the electrolyte solution that flows out of the electrode mixture layer per unit volume of the electrode mixture layer per unit pressure applied to the electrode mixture layer is referred to as a fluidity index value of the electrolyte solution;
the predetermined time for which the electrode mixture layer is pressed is set to three minutes;
the fluidity index value of the electrolyte solution is expressed as “gram (@three minutes) per kilopascal-cubic millimeter”; and
a value obtained by subtracting the fluidity index value of a negative mixture layer from the fluidity index value of a positive mixture layer is greater than or equal to 0.48×10\hat{ }-6.

2. The rechargeable battery according to claim 1, wherein the fluidity index value of the positive mixture layer is in a range of 7.8×10\hat{ }-7 to 8.8×10\hat{ }-6.

3. The rechargeable battery according to claim 1, wherein the positive mixture layer has a thickness in a range of 0.034 millimeters to 0.050 millimeters.

4. The rechargeable battery according to claim 1, wherein the fluidity index value of the negative mixture layer is in a range of 2.4×10\hat{ }-6 to 1.1×10\hat{ }-5.

5. The rechargeable battery according to claim 1, wherein the negative mixture layer has a thickness in a range of 0.060 millimeters to 0.080 millimeters.

6. The rechargeable battery according to claim 1, wherein the positive mixture layer includes a conductive fibrous carbon material.
